(19) United States
(12) Patent Application Publication
(10) Pub. No.: US 2018/0285744 A1
(43) Pub. Date: Oct. 4, 2018

(54) SYSTEM AND METHOD FOR GENERATING MULTIMEDIA KNOWLEDGE BASE

(71) Applicant: ELECTRONICS AND TELECOMMUNICATIONS RESEARCH INSTITUTE, Daejeon (KR)

(72) Inventors: Kyu Chang KANG, Daejeon (KR); Yongjin KWON, Daejeon (KR); Jin Young MOON, Daejeon (KR); Kyoung PARK, Daejeon (KR); Jongyoul PARK, Daejeon (KR); Yu Seok BAE, Daejeon (KR); Sungchan OH, Seoul (KR); Jeun Woo LEE, Gyeryong-si (KR)

(73) Assignee: ELECTRONICS AND TELECOMMUNICATIONS RESEARCH INSTITUTE, Daejeon (KR)

(21) Appl. No.: 15/945,690

(22) Filed: Apr. 4, 2018

(30) Foreign Application Priority Data
Apr. 4, 2017 (KR) 10-2017-0043864

(51) Int. Cl. G06N 5/02; G06F 17/30

(52) U.S. Cl. CPC G06N 5/022; G10L 15/26; G06F 17/30023; G06F 17/3002

(57) ABSTRACT

A system for generating a multimedia knowledge base uses a multimedia information detection unit to detect texted meta information from multimedia data including at least one combination of a text, a voice, an image and a video and allows a knowledge base shaping unit to use the texted meta information and context information of the multimedia data to divide the multimedia data into syntactic information representing extrinsic configuration information and semantic information representing intrinsic meaning information and may shape the syntactic information and the semantic information into the multimedia knowledge.

### CROSS-REFERENCE TO RELATED APPLICATION

This application claims priority to and the benefit of Korean Patent Application No. 10-2017-0043864 filed in the Korean Intellectual Property Office on Apr. 4, 2017, the entire contents of which are incorporated herein by reference.

### BACKGROUND OF THE INVENTION

### (a) Field of the Invention

The present invention relates to a system and a method for generating a multimedia knowledge base, and more particularly, to a system and a method for generating a multimedia knowledge base by extracting and shaping meta information from multimedia data and generating the meta information as a knowledge base.

### (b) Description of the Related Art

Multimedia data through various closed circuit televisions (CCTV), automobile black boxes, drones, and the like as well as multimedia data using personal photographing devices such as smart phones and digital cameras are exploding worldwide. However, since the amount of generated multimedia data is enormous, the user needs a lot of time and efforts to tag the multimedia data one by one or summarize and store the multimedia data and search the multimedia data afterwards. For the reasons, various methods for more quickly and accurately performing a multimedia search and analysis have been researched.

On the other hand, the existing image content recommendation system proposes a method for generating an ontology that analyzes relevance between meta information of an image content to express a correlation between the meta information and recommending an image content to a user through the relevance and similarity between the meta information, user preference, a weight value, an emotion state or the like based on the ontology. However, the method has a problem in that it is difficult to search a detailed information level included in an image or a video,

The existing other image and video search systems use a method for indexing a database using a collection of visual templates to simply search an image and a video from the database.

### SUMMARY OF THE INVENTION

The present invention has been made in an effort to provide a system and a method for generating a multimedia knowledge base capable of quickly searching multimedia data.

An exemplary embodiment of the present invention provides a system for generating a multimedia knowledge base from multimedia data including at least one combination of a text, a voice, an image and a video. The system for generating a multimedia knowledge base system may include a multimedia information detection unit and a knowledge base shaping unit. The multimedia information detection unit may detect texted meta information from the input multimedia data. The knowledge base shaping unit may divide the texted meta information and context information of the multimedia data into syntactic information representing extrinsic configuration information and semantic information representing intrinsic meaning information and may shape the syntactic information and the semantics information into the multimedia knowledge.

The knowledge base shaping unit may use the texted meta information and the context information of the multimedia data to shape the multimedia data as a 5W1H type multimedia knowledge.

The syntactic information may include source information generating the multimedia data, information of the multimedia data generated by the source, and object detection information extracted from a meaning region configuring the multimedia data.

The semantic information may include event information included in the meaning region configuring the multimedia data and context information configuring the event information, and the context information configuring the event information may at least include an agent of the event and a patient of the event.

The system for generating a multimedia knowledge base may further include a knowledge base database (DB) storing the multimedia knowledge and a knowledge base management unit modeling the knowledge base DB to convert and manage the multimedia knowledge into a structure optimized for a search.

The system for generating a multimedia knowledge base may further include a user interface that processes a search request for the multimedia data from the user.

The user interface may extract the 5W1H type search request information from search request information of at least one of a natural language, a text, an image, and a moving picture, transmit the 5W1H type search request information to the knowledge base management unit, and search the knowledge base DB based on the 5W1H type search request information and transmit the search result to the user interface.

The user interface may provide a link for the searched multimedia data and may play the searched multimedia data if the user selects the link.

The multimedia information detection unit may include at least one of a part of speech (PoS) detector that converts a voice input into a text to extract an object or activity included in the voice input, an optical character recognition (OCR) detector that extracts characters from an image input, a part of visuals (PoV) detector that extracts an object or activity included in an input of the image or moving picture from the input of the image or moving picture input, and a visuals to sentence (VtS) detector that extracts a text sentence from the image or moving picture input.

The multimedia information detection unit may further include a control unit that operates the PoS detector, the OCR detector, the PoV detector, and the VtS detector independently or in combination according to the required meta information.

The system for generating a multimedia knowledge base may further include a preprocessing unit preprocessing the multimedia data according to an input specification of each detector in the multimedia information detection unit and transmitting the preprocessed multimedia data to each detector.

The knowledge base shaping unit may deduce and change the texted meta information to a lexicon having highest similarity using a previously generated semantic rule and lexicon-based knowledge ontology if the texted meta information does not match an expression type of the multimedia knowledge and shape the lexicon into the multimedia knowledge.

Another embodiment of the present invention provides a method for generating a multimedia knowledge base from multimedia data including at least one combination of a text, a voice, an image, and a video in a system for generating a multimedia knowledge base. The method for generating a multimedia knowledge base may include detecting texted meta information from the input multimedia data, sorting and shaping the multimedia knowledge of syntactic information representing extrinsic configuration information and a multimedia knowledge of semantic information representing intrinsic meaning information using the texted meta information and context information of the multimedia data, and storing the multimedia knowledge in a knowledge base database (DB).

The shaping may include expressing the multimedia knowledge of the semantic information in a 5W1H type.

The syntactic information may include source information generating the multimedia data, information of the multimedia data generated by the source, and object detection information extracted from a meaning region configuring the multimedia data.

The syntactic information may include event information included in the meaning region configuring the multimedia data and context information including the event information, and the context information configuring the event information may at least include an agent of the event and a patient of the event.

The shaping may include deducing and changing the texted meta information to a lexicon having highest similarity using a previously generated semantic rule and lexicon-based knowledge ontology if the texted meta information does not match an expression type of the multimedia knowledge and quantifying the deduced and changed lexicon into the multimedia knowledge.

The method for generating a multimedia knowledge base may further include modeling the knowledge base DB to convert and store the multimedia knowledge into a structure optimized for a search. The method for generating a multimedia knowledge base may further include extracting the 5W1H type search request information from search request information if the search request information of at least one of a natural language, a text, an image, and a moving picture is received from a user, searching the knowledge base DB based on the 5W1H type search request information, and providing the search result to the user.

The detecting may include acquiring meta information detected from at least one detector detecting different meta information from the multimedia data, and the at least one detector may include at least one of a part of speech (PoS) detector that converts a voice input into a text to extract an object or activity included in the voice input, an optical character recognition (OCR) detector that extracts characters from an image input, a part of visuals (PoV) detector that extracts an object or activity included in an input of the image or moving picture from the input of the image or moving picture input, and a visuals to sentence (VtS) detector that extracts a text sentence from the image or moving picture input.

### BRIEF DESCRIPTION OF THE DRAWINGS

FIG. 1 is a diagram illustrating a system for generating a multimedia knowledge base according to an exemplary embodiment of the present invention.

FIG. 2 is a diagram illustrating an example of a multimedia information detection unit illustrated in FIG. 1.

FIG. 3 is a flowchart illustrating a method for generating a multimedia knowledge base in a system for generating a multimedia knowledge base according to an exemplary embodiment of the present invention.

FIG. 4 is a diagram illustrating an example of an input data of the system for generating a multimedia knowledge base according to an exemplary embodiment of the present invention.

FIG. 5 is a diagram illustrating an example of meta information extracted from the input data illustrated in FIG. 4 in an OCR detector according to the exemplary embodiment of the present invention.

FIG. 6 is a diagram illustrating an example of generating a knowledge base in a knowledge base shaping unit according to an exemplary embodiment of the present invention.

FIG. 7 is a diagram illustrating a user interface illustrated in FIG. 1.

FIG. 8 is a diagram illustrating another example of a system for generating a multimedia knowledge base according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Hereinafter, a system and a method for generating a multimedia knowledge base according to an exemplary embodiment of the present invention will be described in detail with the accompanying drawings.

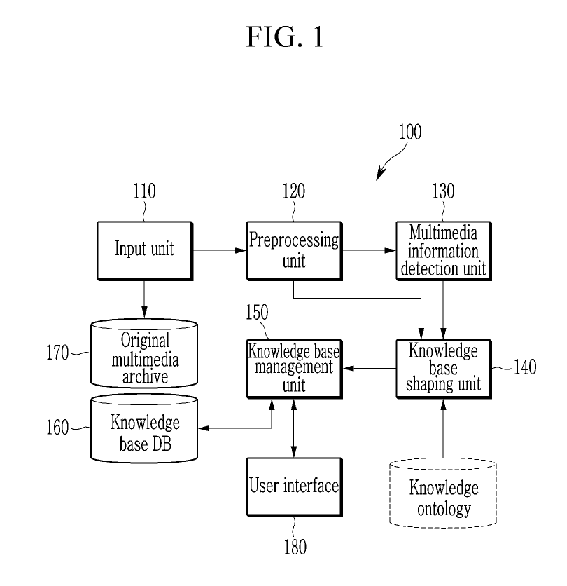

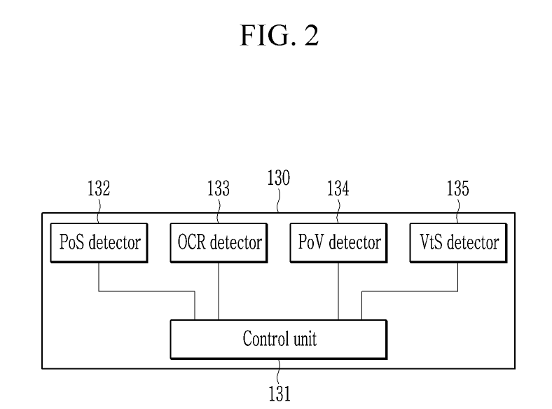

FIG. 1 is a diagram illustrating a system for generating a multimedia knowledge base according to an exemplary embodiment of the present invention and FIG. 2 is a diagram illustrating an example of a multimedia information detection unit illustrated in FIG. 1.

Referring to FIG. 1, a system for generating a multimedia knowledge base 100 includes an input unit 110, a preprocessing unit 120, a multimedia information detection unit 130, a knowledge base shaping unit 140, a knowledge base management unit 150, a knowledge base database (DB) 160, and an original multimedia archive 170. The system for generating a multimedia knowledge base may further include a user interface 180.

The input unit 110 receives an input data and transmits the received input data to the preprocessing unit 120. The input unit 110 may store the received input data in the original multimedia archive 170. According to the exemplary embodiment of the present invention, the input data may be a multimedia data including a combination of a text, a voice, an image, a video, or the like. The multimedia data may include only at least a part of a voice, an image, and a voice according to features of a data source. For example, the multimedia data photographed by a terminal apparatus such as a smart phone may include a voice and a moving picture, and the multimedia data photographed by a CCTV may include only a moving picture. When a specific area is periodically photographed as a still image, the multimedia data may include an image sequence.

The preprocessing unit 120 performs preprocessing such as sampling, a size change, or the like on input data of various source according to an input of each detector of the multimedia information detection unit 130 and transmits the preprocessed data to each detector of the multimedia information detection unit 130. For example, the preprocessing unit 120 may change the number of frames per second if the input data is the moving picture input at 30 frames per second and may dynamically change the size of the input data according to the input specification of each detector of the multimedia information detection unit 130. In addition, the preprocessing unit 120 transmits context information of the input data to the knowledge base shaping unit 140.

The multimedia information detection unit 130 extracts the required meta information based on the preprocessed data.

Referring to FIG. 2, the multimedia information detection unit 130 may include a control unit 131, a part of speech (PoS) detector 132, an optical character recognition (OCR) detector 133, a part of visuals (PoV) detector 134, and a visuals to sentence (VtS) detector 135. FIG. 2 only illustrates the PoS detector 132, the OCR detector 133, the PoV detector 134, and the VtS detector 135, but other third party detector may be additionally used according to the required meta information.

The control unit 131 transmits the data preprocessed by the preprocessing unit 120 to the corresponding detector, and transmits the meta information extracted from the corresponding detector to the knowledge base shaping unit 140.

The PoS detector 132 converts a voice into a text to extract an object (noun) or a behavior/activity (verb) included in the input data based on a text-based parts of speech analysis if the input data includes a voice. That is, the PoS detector 132 may use a text mining technique such as a thematic role analysis in a text obtained from a voice signal and recognize a dialogue content based on a noun or a verb. In addition, the PoS detector 132 may extract meta information as separate context information such as train sound recognition and car sound recognition in the case of a voice signal that cannot be directly converted into a text. The meta information extracted by the PoS detector 132 is as the following Table 1.

TABLE 1

| | Meta information extracted by PoS |
|---|---|
| | detector |
| Mandatory | Verb (Predicate): Event verb |
| | indicating behavior/activity |
| | Noun (Subject, Object): Agent or |
| | patient of behavior/activity as person |
| | or thing |
| Option | Adjective: describes a noun |
| | Determiner: limits or ‘determine’ a |
| | noun |
| | Adverb: describes a verb, adjective |
| | or adverb |
| | Pronoun: replace a noun |
| | Prepositon: links a noun to another |
| | word |
| | Conjunction: joins clauses or |
| | sentences or words |
| | Interjection: short exclamation, |
| | sometimes inserted into a sentence |

The OCR detector 133 extracts characters on an image if the input data is a frame or an image extracted from a moving picture. For example, the OCR detector 133 may recognize a vehicle number, a traffic sign or the like that appear on an image. The vehicle number recognized in this way may be used as attribute values of a vehicle detected in the input data, and the recognized traffic sign may be used as the context information describing the input data. The meta information extracted by the OCR detector 133 is as the following Table 2.

TABLE 2

| | Meta information extracted by OCR |
|---|---|
| | detector |
| Mandatory | Target: Recognition object (for |
| | example: vehicle number plate, traffic |
| | sign, sign, or the like, and a target can |
| | be operated by interworking with PoV) |
| | Recognized Text: Recognized |
| | character string |

The PoV detector 134 extracts an object (noun) and a behavior/activity (verb) based on a neural network or a machine learning technique such as a convolutional neural network (CCN) or a recurrent neural network (RNN) if the input data is an image or a moving picture. For example, the PoV detector 134 may detect things (noun), events (verb) information or the like in each image or an image frame or a connected image and image frame. The meta information extracted by the PoV detector 134 is as the following Table 3.

TABLE 3

| | Meta information extracted by PoV |
|---|---|
| | detector |
| Mandatory | Noun (Subject, Object): thing/object |
| | noun list detected and recognized in |
| | image or frame, agent or patient |
| | candidate of verb (predicate) |
| | Verb (predicate): behavior/activity |
| | event verb list deduced by |
| | accumulating detected thing/object |
| | relation. |

The VtS detector 135 automatically converts an input data into a text sentence and extracts it by a neural network or a machine learning technique if the input data is an image or a moving picture. For example, the VtS detector 135 may extract a sentence by an image captioning technique or the like if the input data is an image and extract a sentence by the CNN, the RNN or the like if the input data is a moving picture. The meta information extracted by the VtS detector is as the following Table 4.

TABLE 4

| | eta information extracted by |
|---|---|
| | VtS detector |
| Mandatory | Sentence: Sentence configured of |
| | (Subject + Predicate + Ojbect) |
| | Verb (Predicate): Behavior/activity |
| | event verb |
| | Noun (Subject): Agent of behavior/ |
| | activity event |
| | Noun (Object): Patient of behavior/ |
| | activity event |

The control unit 131 may be used by configuring the PoS detector 132, the OCR detector 133, the PoV detector 134, and the VtS detector 135 independently or in various combinations according to the detection function of the required meta information. For example, the OCR detector 133 may interwork with the PoV detector 134 to determine a region for detection to share region information of an interest object like a vehicle. Further, the PoV detector 134 may interwork with the OCR detector 133 to use the internally recognized vehicle number as attributes of the vehicle extracted from the OCR detector 133.

The PoS detector 132, the OCR detector 133, the PoV detector 134, and the VtS detector 135 may be operated in a centralized manner in one system, and may also be logically distributed and operated in different machines and mutually share the result.

The knowledge base shaping unit 140 defines a multimedia knowledge expression type such as schema, and dynamically fuses/composes the meta information detected by each detector 132 to 135 of the multimedia information detection unit 130 with the context information of the input data received from the preprocessing unit 120 and shapes it into the multimedia knowledge according to the multimedia knowledge expression form. The knowledge base shaping unit 140 may deduce and change the meta information detected by each detector 132 to 135 of the multimedia information detection unit 130 into a lexicon having highest similarity using a previously generated semantic rule and lexicon-based knowledge ontology if the detected meta information does not match the multimedia knowledge expression type to shape the meta information detected by each detector 132 to 135 of the multimedia information detection unit 130 into the multimedia knowledge. The previously generated semantic rule and lexicon-based knowledge ontology may be separately generated by a traditional text mining technique in terms of a linguistics model based on a text and video corpus and used.

According to the exemplary embodiment of the present invention, a previously defined multimedia knowledge expression may be largely divided into syntactic information and semantic information. The syntactic information represents extrinsic configuration information of the multimedia data. The semantic information represents intrinsic meaning information of the multimedia data. For example, the syntactic information and the semantic information may be represented as following Table 5.

TABLE 5

| | Multimedia knowledge expression |
|---|---|
| Syntactic information | Cameras: Camera related |
| | information generating multimedia |
| | data |
| | Streams: Multimedia data stream |
| | information generated by camera |
| | Scenes: Object/thing detection/ |
| | recognition information extracted in |
| | meaning region configuring multimedia |
| | data stream |
| | Frames: Meaning region start and |
| | end frame |
| | Static objects: Location (left-top |
| | coordinates, width, height) in meaning |
| | region |
| | Objects: Object location (left-top |
| | coordinates, width, height) in each |
| | frame |
| Semantic information | Event (predicate): Event information |
| | included in meaning region |
| | Context: Context information |
| | configuring event information |
| | Mandatory |
| | Who (subject): agent of |
| | event |
| | What (object): patient |
| | of event |
| | Option |
| | How: event auxiliary |
| | description (extract information based |
| | on preposition + object relation) using |
| | phase relation of object, for example: |
| | by bus, into an entrance, into a pool, |
| | out of a car, etc) |
| | Where: event |
| | generation location |
| | When: event |
| | generation time |
| | Why: event generation |
| | reason |

The knowledge base shaping unit 140 may express, store, and exchange the multimedia knowledge in a markup language like extensible markup language (XML), or a data format such as JavaScript object notation (JSON).

The knowledge base management unit 150 converts the multimedia knowledge generated from the knowledge base shaping unit 140 into hierarchical architecture optimized for a target service based on DB modeling and stores and manages the converted hierarchical architecture in the knowledge base DB 160. For example, the knowledge base management unit 150 may use an event identifier (ID) as a primary key to facilitate an event search in case of a service where an event search is a key element. The knowledge base management unit 150 may use the object identifier as the primary key in case of a service where a relation between objects needs to be searched and may index the relation between the objects to increase search performance. In addition, the knowledge base management unit 150 searches the knowledge base DB 160 according to the search request of the multimedia data from the user through the user interface 180.

The knowledge base management unit 150 may generate the knowledge base DB 160 in one machine and manage the generated knowledge base DB 160 in a centralized manner, and may physically distribute the knowledge base DB 160 and may store and manage the knowledge base DB 160 in a distributed database form.

The knowledge base DB 160 stores the multimedia knowledge optimized for the search.

The original multimedia archive 170 stores the multimedia data corresponding to the input data.

The user interface 180 provides an interface with a user, and supports the search for the multimedia data of the user from the knowledge base DB 160 generated as the multimedia knowledge base.

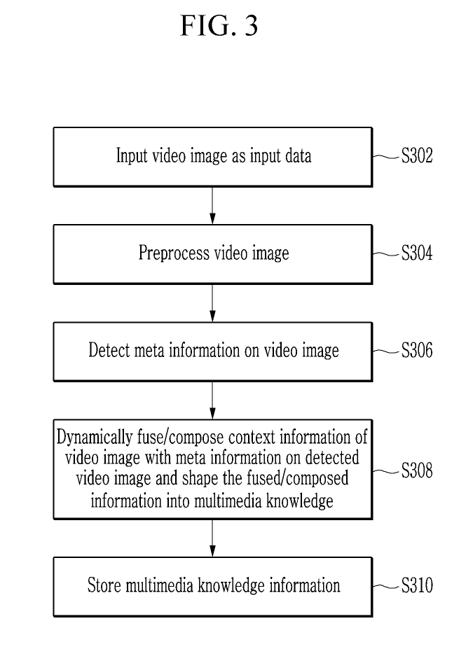

Then, in the system for generating a multimedia knowledge base according to the exemplary embodiment of the present invention, a method for generating a multimedia knowledge base using a video image recorded by a high definition (HD) CCTV as an input data will be described in detail with reference to FIGS. 3 to 5.

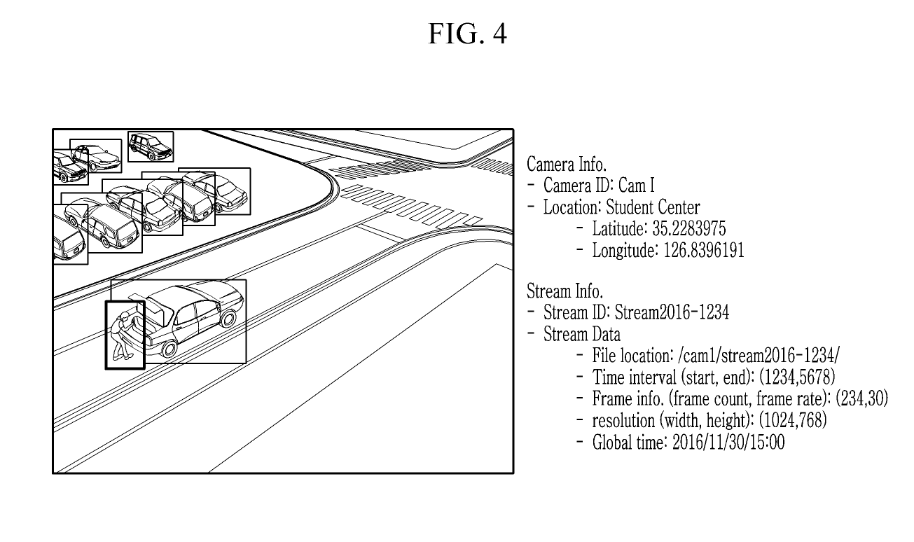

FIG. 3 is a flow chart illustrating a method for generating a multimedia knowledge base in a system for generating a multimedia knowledge base according to an exemplary embodiment of the present invention and FIG. 4 is a diagram illustrating an example of an input data of the system for generating a multimedia knowledge base according to an exemplary embodiment of the present invention.

Referring to FIG. 3, among video streams photographed by a camera where an ID installed in a student's hall located at a latitude of 35.22° and a longitude of 126.83° is ‘Cam 1’, a video image photographed at 3:00 pm on Nov. 30, 2016 where a stream ID is ‘stream 2016-1234’ is input to the input unit 110 as the input data (S302). That is, the input data as illustrated in FIG. 4 is input to the input unit 110. A resolution of the video image is (1024*768), and the corresponding video image is stored in a ‘/cam1/stream2016-1234’ directory of the original multimedia archive 170. A ground truth of the video image is that a person is putting something down from a car located at a front of a student center at 3 pm. The ground truth is a real ground truth that is a comparison reference at the time of evaluating how much the meta information detected by the system for generating a multimedia knowledge base 100 is accurate.

The video image input to the input unit 110 is transmitted to the preprocessing unit 120. The preprocessing unit 120 preprocesses the input video image according to the input specification of each detector 132 to 135 of the multimedia information detection unit 130 (S304).

For convenience of explanation, it is described that the PoS detector 132 and the VtS detector 135 are not used, and only the OCR detector 133 and the PoV detector 134 are operated according to the input data and constraints of the available detector. In addition, it is assumed that the OCR detector 133 does not interwork with the PoV detector 134. The preprocessing unit 120 splits the data stream of the input image into the meaning region according to the input specification of the OCR detector 133 and extracts a representative frame image in each meaning region. The representative frame image is reduced to a size of 640×480 and then transmitted to the multimedia information detection unit 130. As a method for extracting a representative frame image in the preprocessing unit 120, various methods such as method for extracting an intermediate frame of an image to be processed or compare front-to-back frames in an image frame to extract a frame having a larger variation may be used. In addition, the preprocessing unit 120 extracts a consecutive frame image in the image of the meaning region, and samples the corresponding image at 5 frames per second and then transmits the sampled image to the multimedia information detection unit 130.

If receiving the representative frame image from the preprocessing unit 120, the control unit 131 of the multimedia information detection unit 130 requests the character recognition while transmitting the corresponding representative frame image to the OCR detector 133. In addition, if receiving the consecutive frame image from the preprocessing unit 120, the control unit 131 of the multimedia information detection unit 130 requests the object (noun) and behavior/activity (verb) recognition while transmitting the corresponding frame images to the PoV detector 134.

The OCR detector 133 may detect characters from the representative frame image transmitted from the preprocessing unit 120 and output the detection result in a type such as [model ID] [probability, left-top coordinates (left, top), width, height, recognized character string]. The model ID represents the identifier of the character detection model used to detect characters and the probability represents the probability that the detected character value is true. The left-top coordinates (left, top), width, and height represent the left-top coordinates (left, top), width, and height of a region in which characters are detected.

The PoV detector 134 uses the image frames received from the preprocessing unit 120 to detect the object/thing (noun) existing in the image and accumulates the detected object/thing temporally and spatially to deduce the behavior/activity (verb) event. The PoV detector 134 may output the detected and deduced information in a type such as a set of the [model ID] [probability, frame number, left-top coordinates (left, top), width, height, thing/object (noun) class] and a set of the [model ID] [probability, start frame, end frame, left-top coordinates (left, top) of an event bounding box, width, height, behavior/activity (verb) class]. For example, a large rectangular area including an event of ‘riding’, for example, areas of ‘car’ and ‘person’ which are subjects of a car riding behavior becomes an event generation area.

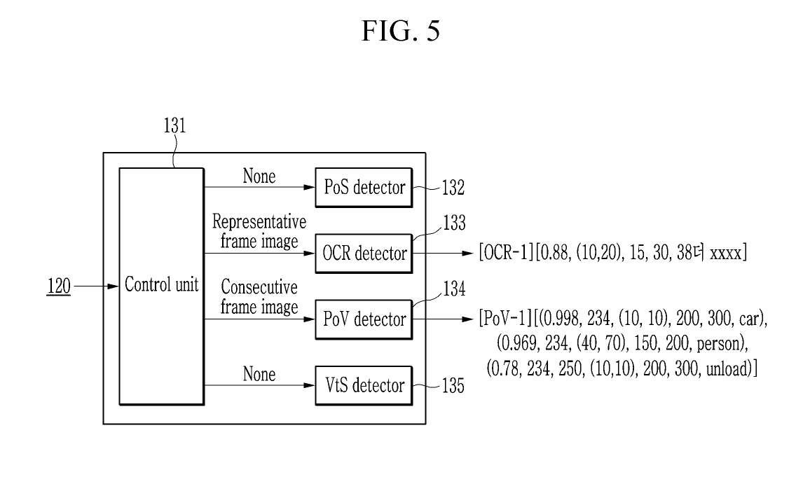

FIG. 5 is a diagram illustrating an example of meta information extracted from the input data illustrated in FIG. 4 in an OCR detector according to the exemplary embodiment of the present invention.

As illustrated in FIG. 5, the OCR detector 133 having a model ID of OCR-1 may recognize a vehicle number “38 Duh xxxx” with the probability of 0.88 from the representative frame image of the meaning region in which left-top coordinates are 10 and 20, a width is 15, and a height is 30 and output the recognized results such as “[OCR-1] [0.88, (10 and 20), 15, 30, 38 Duh xxxx]”.

The PoV detector 134 in which the model ID is PoV-1 detects an object/thing (noun) ‘car’ with a probability of 0.998 from a meaning region in which in an image frame of the frame number 234, left-top coordinates of an image are 10 and 10, a width is 200 and a height is 300, detects an object/thing (noun) ‘person’ with a probability of 0.969 from a meaning region in which in the image frame of the frame number 234, the left-top coordinates of the image are 40 and 70, the width is 150, and the height is 200, and recognizes a behavior/activity event (verb) ‘unload’ with a probability of 0.78 from a meaning region in which in an image frame of a section from the frame number 234 to 250, the left-top coordinates are 10 and 10, the width is 200, and the height is 300. In this case, the PoV detector 134 that is PoV-1 outputs detection results in type such as “[PoV-1][ (0.998, 234, 10 and 10, 200, 300, car), (0.969, 234, 40 and 70, 150, 200, person), (0.78, 234, 250, 10 and 10, 200, 300, unload)].

In this way, the multimedia information detection unit 130 uses various third party detection solutions to detect the meta information on the video image that is the input data (S306), and transmits the detected meta information to the knowledge base shaping unit 140.

The knowledge base shaping unit 140 dynamically fuses/composes the context information of the video image received from the preprocessing unit 120 with the meta information on the video image detected from the multimedia information detection unit 130 to shape the input data based on the previously defined multimedia knowledge expression (S308). The context information of the input data may include information, for example, the Cam 1 that is the camera ID, the ‘Stream2016-1234’ that is the stream ID, the student center that is a photographing location, and 3 pm that is a photographing time.

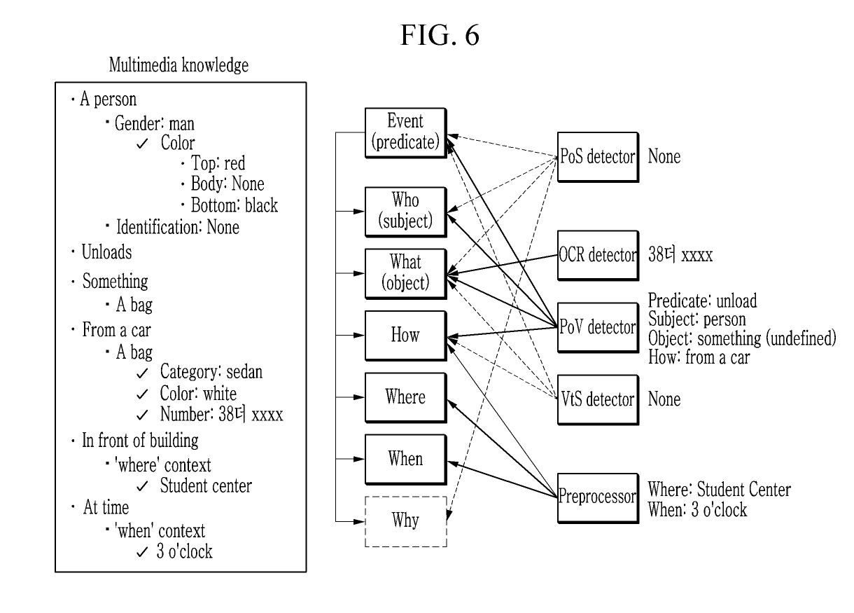

FIG. 6 is a diagram illustrating an example of generating a knowledge base in a knowledge base shaping unit according to an exemplary embodiment of the present invention.

The knowledge base shaping unit 140 receives the context information on the input data from the preprocessing unit 120 and the meta information from the OCR detector 133 and the PoV detector 134 as illustrated in FIG. 5. As illustrated in FIG. 6, the knowledge base shaping unit 140 may map the meta information to the previously defined semantic type of the 5W1H-based multimedia knowledge and shape it.

Referring back to FIG. 3, the knowledge base management unit 150 stores the multimedia knowledge information received from the knowledge base shaping unit 140 in the knowledge base DB 160 (S310). The knowledge base management unit 150 may model the knowledge base DB 160 to be suitable for the search to support a quick search for the stored multimedia knowledge information to store and manage the multimedia knowledge information. If the knowledge base DB 160 is modeled, since the multimedia knowledge information itself is basically configured in a ‘subject+predicate+object’ form, the DB table structure storing the multimedia knowledge information may be configured by additionally including a (subject, predicate, object) record for convenience of search. The knowledge base management unit 150 basically constructs a base DB based on the 5W1H for generalization of search and again performs indexing based on items that are mainly searched according to a usage of a target service, thereby increasing search performance. Tables 6 and 7 show an example of a table configured to support the quick search in the knowledge base management unit 150.

TABLE 6

| No | Filed Name | Field Type | Key | Description |
|---|---|---|---|---|
| 1 | id | INTEGER | PK | activity id (auto |
| | | | | increment) |
| 2 | scene_ref | INTEGER | FK (scene: id) | membership scene |
| | | | | id of activity |
| 3 | verb | VARCHAR(100) | | verb describing |
| | | | | activity |
| 4 | subject | VARCHAR(100) | FK (object: id) | subject of activity |
| 5 | object | VARCHAR(100) | FK (object: id) | object of activity |
| 6 | frame_start | INTEGER | | activity observation |
| | | | | start frame |
| 7 | frame_end | INTEGER | | activity observation |
| | | | | end frame |
| 8 | time_start | INTEGER | | activity observation |
| | | | | start time |
| 9 | time_end | INTEGER | | activity observation |
| | | | | end time |
| 10 | type | VARCHAR(100) | | activity type (ex. |
| | | | | composite verb, |
| | | | | single verb) |
| 11 | event_ref | INTEGER | FK (EVENT: | membership image |
| | | | id) | id of activity |

TABLE 7

| No | Filed Name | Field type | Key | Description |
|---|---|---|---|---|
| 1 | id | INTEGER | PK | object id (auto |
| | | | | increment) |
| 2 | activity-ref | INTEGER | FK (activity_ | membership |
| | | | ref: id) | activity id of |
| | | | | object |
| 3 | scene_ref | INTEGER | FK (SCENE: | membership |
| | | | id) | image id of object |
| 4 | name | VARCHAR(100) | | object name |
| 5 | type | VARCHAR(100) | | object type |
| 6 | color_body | VARCHAR(100) | | object color |
| | | | | (body)-color of |
| | | | | general object |
| 7 | color_top | VARCHAR(100) | | object color (top)- |
| | | | | color of top of |
| | | | | normal person |
| | | | | object |
| 8 | color_bottom | VARCHAR(100) | | object color |
| | | | | (bottom)-color of |
| | | | | bottom of normal |
| | | | | person object |
| 9 | frame_start | INTEGER | | object appearance |
| | | | | start frame |
| 10 | frame_end | INTEGER | | object appearance |
| | | | | end frame |
| 11 | time_start | INTEGER | | object appearance |
| | | | | start time |
| 12 | time_end | INTEGER | | object appearance |
| | | | | end time |
| 13 | moving | TINYINT | | motion or not (0: |
| | | | | static object, 1: |
| | | | | dynamic object) |

That is, the object information associated with the behavior/activity to support the quick search may be configured in the table form as shown in the above Table 6 and the object information existing in the image may be configured in the table form as shown in the above 7.

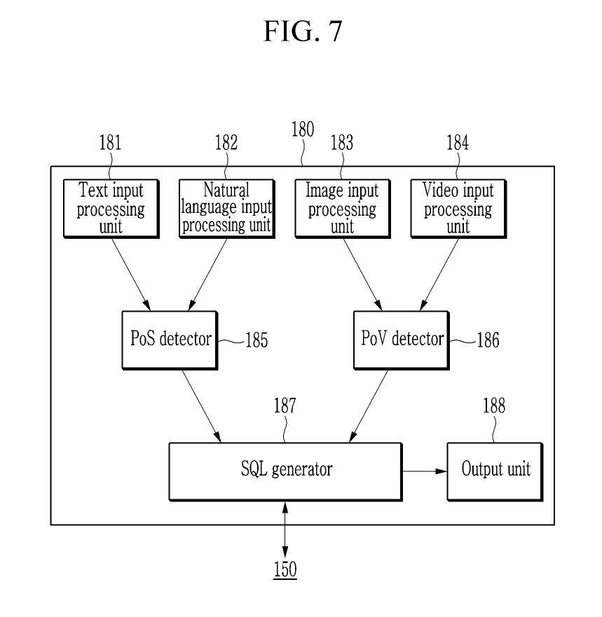

FIG. 7 is a diagram illustrating a structure of a user interface illustrated in FIG. 1.

Referring to FIG. 7, the user interface 180 may include a text input processing unit 181, a natural language input processing unit 182, an image input processing unit 183, a video input processing unit 184, a PoS detector 185, a PoV detector 186, and a structured query language (SQL) generator 187. In addition, the user interface 180 may further include an output unit 188.

The text input processing unit processes a text input received from a user and transmits the text input to the PoS detector 185.

The natural input processing unit 182 processes the natural language input received from the user and transmits the text result obtained by processing the natural language input to the PoS detector 185.

The image input processing unit 183 processes the image input received from the user and transmits the image input to the PoV detector 186.

The video input processing unit 184 processes the video input received from the user and transmits the video input to the PoV detector 186.

The PoS detector 185 extracts the 5W1H information from the text received from the text input processing unit 181 and/or the natural language input processing unit 182, and transmits the extracted information of 5W1H to the SQL generator 187.

The PoV detector 186 extracts the search request information in the 5W1H type from the image and/or video received from the image input processing unit 183 and/or the video input processing unit 184, and transmits the extracted search request information of 5W1H to the SQL generator 187.

Meanwhile, if the input such as the natural language, the text, the image, and the moving picture is compositely input independent of the sequence, the text input processing unit 181, the natural language input processing unit 182, the image input processing unit 183, and the video input processing unit 184 may be sequentially operated to process the corresponding input.

The SQL generator 187 transmits the search request information of 5W1 H to the knowledge base management unit 150 to request the search, and receives the search result from the knowledge base management unit 150.

The output unit 188 provides the search result from the knowledge base management unit 150 to the user. At this time, the search result may be output in a list type or provide a specific link for the search result to the user. If the user selects the specific link, the output unit 188 may play the original multimedia data.

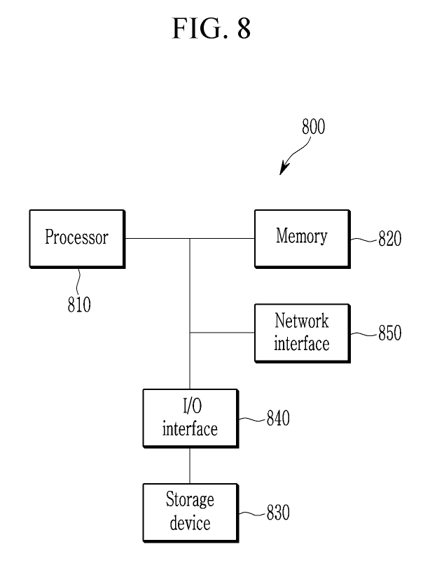

FIG. 8 is a diagram illustrating another example of a system for generating a multimedia knowledge base according to an exemplary embodiment of the present invention, in which a computer system capable of performing at least some of the functions of the system for generating a multimedia knowledge base described with reference to FIG. 1 is illustrated.

Referring to FIG. 8, a system 800 for generating a multimedia knowledge base includes at least one processor 810, a memory 820, a storage device 830, an input/output (I/O) interface 840, and a network interface 850.

The processor 810 may be implemented as a central processing unit (CPU), other chipsets, a microprocessor, or the like.

The memory 820 may be implemented as RAMs such as a dynamic random access memory (DRAM), a rambus DRAM (RDRAM), a synchronous DRAM (SDRAM), a static RAM (SRAM), or the like.

The storage device 830 may be implemented as optical disks such as a hard disk, a compact disk read only memory (CD-ROM), CD rewritable (CD-RW), a digital video disk ROM (DVD-ROM), a DVD-RAM, a DVD-RW disk, and a blu-ray disk, a flash memory, and permanent or volatile storage devices such as various types of RAMs.

The I/O interface 840 enables the processor 810 and/or memory 820 to access the storage device 830. In addition, the I/O interface 840 may provide an interface with a user.

The network interface 850 provides an interface with network entities such as a machine, a terminal, and a system through a network.

The processor 810 may perform at least some of the functions of the input unit 110, the preprocessing unit 120, the multimedia information detection unit 130, the knowledge base shaping unit 140, the knowledge base management unit 150, and the user interface 180 which are described with reference to FIGS. 1 to 8. The processor 810 may load a program command for implementing at least some of the functions of the input unit 110, the preprocessing unit 120, the multimedia information detection unit 130, the knowledge base shaping unit 140, the knowledge base management unit 150, and the user interface 180, which are described with reference to FIGS. 1 to 8, into the memory 820 and perform a control to perform the operation described with reference to FIGS. 1 to 8. The program command may be stored in the storage device 830 or stored in other systems connected to the network.

The memory 820 or the storage device 830 may include the knowledge base DB and the original multimedia archive 170.

According to an exemplary embodiment of the present invention, the combinations of the language analysis detector, the image analysis detector, the video analysis detector or the like may be applied to the multimedia data including the combinations of the voice, the image, the video or the like to extract the meta information included in the multimedia, thereby extracting various metal information and various extracted meta information may be mapped in the 5W1 H (who, what, where, when, why, how) type to be generated as the knowledge base, thereby implementing the multimedia summary indexing. In addition, it is possible to easily provide the text, natural language, image, and video-based search function based on the generated multimedia knowledge base.

Although the exemplary embodiment of the present invention has been described in detail hereinabove, the scope of the present invention is not limited thereto. That is, several modifications and alterations made by those skilled in the art using a basic concept of the present invention as defined in the claims fall within the scope of the present invention.

What is claimed is:

1. A system for generating a multimedia knowledge base from multimedia data including at least one combination of a text, a voice, an image and a video, comprising:
a multimedia information detection unit detecting texted meta information from the input multimedia data; and
a knowledge base shaping unit dividing the texted meta information and context information of the multimedia data into syntactic information representing extrinsic configuration information and semantics information representing intrinsic meaning information and shaping the texted meta information and the context information into the multimedia knowledge.

2. The system of claim 1, wherein:
the knowledge base shaping unit uses the texted meta information and the context information of the multimedia data to shape the multimedia data as a 5W1 H type multimedia knowledge.

3. The system of claim 1, wherein:
the syntactic information includes source information generating the multimedia data, information of the multimedia data generated by the source, and object detection information extracted from a meaning region configuring the multimedia data.

4. The system of claim 1, wherein:
the semantic information includes event information included in the meaning region configuring the multimedia data and context information configuring the event information, and
the context information configuring the event information at least includes an agent of the event and a patient of the event.

5. The system of claim 1, further comprising:
a knowledge database (DB) storing the multimedia knowledge; and
a knowledge base management unit modeling the knowledge base DB to convert and manage the multimedia knowledge into a structure optimized for a search.

6. The system of claim 5, further comprising:
a user interface that processes a search request for the multimedia data from the user.

7. The system of claim 6, wherein:
the user interface extracts a 5W1H type search request information from search request information of at least one of a natural language, a text, an image, and a moving picture, and transmits the 5W1H type search request information to the knowledge base management unit, and
the knowledge base management unit searches the knowledge base DB based on the 5W1H type search request information and transmits the search result to the user interface.

8. The system of claim 5, wherein:
the user interface provides a link for the searched multimedia data and plays the searched multimedia data if the user selects the link.

9. The system of claim 1, wherein:
the multimedia information detection unit includes at least one of:
a part of speech (PoS) detector that converts a voice input into a text to extract an object or activity included in the voice input;
an optical character recognition (OCR) detector that extracts characters from an image input;
a part of visuals (PoV) detector that extracts an object or activity included in an input of the image or moving picture from the input of the image or moving picture input; and
a visuals to sentence (VtS) detector that extracts a text sentence from the image or moving picture input.

10. The system of claim 9, wherein:
the multimedia information detection unit further includes a control unit that operates the PoS detector, the OCR detector, the PoV detector, and the VtS detector independently or in combination according to the required meta information.

11. The system of claim 9, further comprising:
a preprocessing unit preprocessing the multimedia data according to an input specification of each detector in the multimedia information detection unit and transmitting the preprocessed multimedia data to each detector.

12. The system of claim 1, wherein:
the knowledge base shaping unit deduces and changes the texted meta information to a lexicon having highest similarity using a previously generated semantic rule and lexicon-based knowledge ontology if the texted meta information does not match an expression type of the multimedia knowledge and shapes the lexicon into the multimedia knowledge.

13. A method for generating a multimedia knowledge base from multimedia data including at least one combination of a text, a voice, an image, and a video in a system for generating a multimedia knowledge base, the method comprising:
detecting texted meta information from the input multimedia data;
sorting and shaping the multimedia knowledge of syntactic information representing extrinsic configuration information and a multimedia knowledge of semantic information representing intrinsic meaning information using the texted meta information and context information of the multimedia data; and
storing the multimedia knowledge in a knowledge base database (DB).

14. The method of claim 13, wherein:
the shaping includes expressing the multimedia knowledge of the semantic information in a 5W1 H type.

15. The method of claim 13, wherein:
the syntactic information includes source information generating the multimedia data, information of the multimedia data generated by the source, and object detection information extracted from a meaning region configuring the multimedia data.

16. The method of claim 13, wherein:
the semantic information includes event information included in the meaning region configuring the multimedia data and context information configuring the event information, and
the context information configuring the event information at least includes an agent of the event and a patient of the event.

17. The method of claim 13, wherein:
the shaping includes:
deducing and changing the texted meta information to a lexicon having highest similarity using a previously generated semantic rule and lexicon-based knowledge ontology if the texted meta information does not match an expression type of the multimedia knowledge; and
quantifying the deduced and changed lexicon into the multimedia knowledge.

18. The method of claim 13, further comprising:
modeling the knowledge base DB to convert and store the multimedia knowledge into a structure optimized for a search.

19. The method of claim 18, further comprising:
extracting the 5W1H type search request information from search request information if the search request information of at least one of a natural language, a text, an image, and a moving picture is received from a user;
searching the knowledge base DB based on the 5W1H type search request information; and
providing the search result to the user.

20. The method of claim 13, wherein:
the detecting includes acquiring meta information detected from at least one detector detecting different meta information from the multimedia data, and
the at least one detector includes at least one of: a part of speech (PoS) detector that converts a voice input into a text to extract an object or activity included in the voice input;
an optical character recognition (OCR) detector that extracts characters from an image input;
a part of visuals (PoV) detector that extracts an object or activity included in an input of the image or moving picture from the input of the image or moving picture input; and
a visuals to sentence (VtS) detector that extracts a text sentence from the image or moving picture input.
